(19) United States
(12) Patent Application Publication
(10) Pub. No.: US 2007/0219862 A1
(43) Pub. Date: Sep. 20, 2007

(54) System and method for identifying and processing recyclables

(75) Inventors: John W. Casella, Rutland, VT (US); Sean Duffy, Huntersville, NC (US); S. Graham Stevens, Charlotte, NC (US)

Correspondence Address: Kevin M. Farrell;Pierce Atwood, Suite 350, One New Hampshire Avenue, Portsmouth, NH, 03801, US

(73) Assignee: Casella Waste Systems, Inc., Rutland, VT (US)

(21) Appl. No.: 11/387,077

(22) Filed: Mar. 20, 2006

(51) Int. Cl. G06Q 30/00

(52) U.S. Cl. 705/14

(57) ABSTRACT

A system and methods for encouraging a user to continue recycling behavior through various rewards systems and economic benefits, each of which contribute to the overall efficiency and sustainability of a recycling program. The system includes both hardware and software components that are adapted to receive, quantify and assess the quality of recyclable goods. Further, a method includes cooperating with the system to provide users with economic incentives to increase both the quantity and the quality for recycling. Further still, a method includes steps of receiving recyclables from a recyclables container associated with a user, electronically capturing data relating to individual recycled items, and providing a benefit to the user associated with the recyclables container in response to both the quantity and the quality of the recyclables received.

### BACKGROUND OF THE INVENTION

1. Field of the Invention

The present invention relates generally to environmental protection and sustainability, and more specifically to systems and methods for improving the recycling behavior of various entities.

2. Discussion of Background Information

Recycling programs have become more commonplace in the United States and other developed countries through the end of the twentieth century and the beginning of the twenty-first century as consumers, businesses and governments realized the environmental and economic savings to be generated through recycling of goods. The most commonly known recyclable materials are paper, corrugated boards, aluminum, steel and other sheet metals, batteries and certain chemical compounds, plastics of varying types and glass. The implementation of higher technology automated equipment in material recovery facilities (MRFs) has further enabled a large volume of material to be collected, sorted and recovered with increasing speed and efficiency.

In spite of the improvements in recycling throughout the past twenty years, the overall rate of consumption of goods still greatly outpaces the rate at which recyclable materials are reintroduced into the stream of goods. This increased consumer and business demand for goods will continue to strain the economic and environmental resources of various countries and eventually the global community at large. What is needed therefore is a mechanism by which the incentives to recycle are increased dramatically for individuals, businesses, communities and government entities.

Several attempts have been made in the past decade to provide numerous incentives for recycling for individuals. For example, Japanese laid open patent applications 2002-297840 (2001) and 2005-008339 (2003) are typical of those types of systems that measure an individuals recycling behavior and, through an integrated system of measurement, analysis and reward, provide incentives for said individuals to increase their gross recycling. However, although these types of inventions are useful in the abstract, they do not address the issue as to the quality of those goods recycles. By merely creating incentives to recycle, the state of the art increases the probability that users will try to recycle goods that are not fit for processing in order to retain rewards or other benefits. In particular, as the state of the art measures the quantity of recyclable materials by mass quantity only, there is a significant incentive for users to overweight their containers using low-quality or non-recyclable materials in order to obtain the greater benefits.

With respect to the present invention, the point of departure from the prior art lies in the electronic capture of data relating to individual recycled items, and the electronic association of this data with a user from whom the recyclables are received. According to an aspect of the present invention, a wealth of knowledge can be gained from the mining of this electronic data, and this information can be used for a variety of purposes. For example, information relating to the recycling behavior of a user of a recycling system can be used to promote, based on incentive, improved recycling behavior. As will be discussed in greater detail below in connection with specific figures, such rewards can be provided in a variety of formats. As a general proposition to the present invention, it will be recognized that the electronic capture of data relating to individual recycled items received from a user can be recorded, and improvement in recycling behavior by the user can be rewarded over time.

Further still, with respect to the present invention, electronic data capture can be accomplished in a variety of ways, as will be discussed in greater detail in connection with specific figures below. Some forms of electronic data capture will provide information relating to the type of material being recycled (e.g., glass, aluminum, specific types of plastics, etc.) according to an aspect of the invention. Further, in many instances, the identity of the manufacturer who placed the product associated with the recycled material into the stream of commerce may be identifiable. For example, using optical recognition software, electronic images of recyclables from a user's recycling container may be scanned and the corporate entity associated with the product originally packaged in the recyclable identified. Information of this type is of great value to the corporate entity referred to in the preceding sentence. For example, information relating to the success of a geographic marketing program can be directly assessed.

Also, with respect to the present invention, recyclables received are associated with a user. The user may be an individual, group of individuals or a user consortium such as a family, a classroom in a school, residents of a particular apartment building, one or more municipalities, groups of one or more businesses, any individual or group (or any combination thereof) etc. The recyclables according to the instant invention may be received from a conventional curbside recyclables container or tote. Alternatively, the recyclables may be received at a transfer station in situations where curbside recycling is impractical due to population density considerations (e.g., in urban areas or in rural areas).

Further still, with respect to the present invention, recyclables received are associated with a user, and this association is recorded electronically. For example, in a curbside recycling environment, the recyclables container may bear an RFID tag, which can be identified by a reader at the time of pickup. Alternatively, the present invention may provide, in the absence of specific RFID tags, GPS data that may be recorded which identifies the specific location of the pickup vehicle at the time that a particular recycling container is picked up. The user may be inferred from the GPS data in this context. In the rural or urban settings in which curbside pickup is impractical, a user may according the present invention be associated with recyclables through the presentation of an identification card or key fob which may be read electronically by a card reader or bar code scanner at a transfer station. These few examples are not intended to be limiting—one skilled in the art will recognize many ways in which received recyclables can be electronically associated with a particular user or user consortium.

Thus, as the incentives to recycle increase, the potential for abuse of those systems with little oversight as to the quality of the goods recycled is greatly increased. Moreover, as there is a greater influx of low-quality materials into the processing stream, the efficiency, profitability and incentives for collectors and processors to recycle is diminished. Thus, although the state of the art may induce greater recycling, it does nothing to increase the overall efficiency and environmental benefits of recycling, as the existing systems provide benefits that are at cross-purposes with those of the collection and processing companies.

What is needed therefore is a system or method of inducing recycling that has the essential benefit of providing a streamlined system or method through which a user can be easily rewarded for its behavior, while simultaneously ensuring that the quality of goods to be recycled is such that the overall environmental and economic health of the community is maintained.

### SUMMARY OF THE INVENTION

Accordingly, the present invention includes a system and associated methods for encouraging a user to continue its recycling behavior through various rewards systems and economic benefits, each of which contribute to the overall efficiency and sustainability of a recycling program. The system, in its various embodiments, includes both hardware and software components that are adapted to receive, quantify and assess the quality of recyclable goods. In detailed embodiments described below, the system includes a collection vehicle, i.e., a truck, having means for electronically determining the presents of individual materials from the recyclable materials and a weight and/or volume of recyclable materials, as well as an electronic measurement means for assessing the quality of the recyclables. The latter may include at least a plurality of optical components, such as for example video and still cameras, optical and optoelectronic sensors, as well as optical scanner such as those used in the reading of UPC bar codes.

The collection vehicle is adapted to communicate with or interact with a recyclables container, preferably through automated means such as electronic or optoelectronic communications that are known in the art. One such communication protocol is radio frequency identification, or RFID. The container is connectable to or in communication with a transmitter, such as an RFID tag, that contains embedded data including the identity of the user, the identity of the container, and the like. Reception of the recyclables involves interacting with the container, at which time the data regarding the user identity is received by vehicle computing means disposed within the collection vehicle. The vehicle computing means is communicable with a central computer, which includes a plurality of databases, engines and accounts for assessing the quantity and quality of an individual user's recyclables and providing a reward to a user in response thereto. The reward is readily accessible to the user through the user account, or through a physical or electronic mail address associated therewith.

Other aspects of the system of the present invention allow it to operate in more rural areas where the collection service is provided at a transfer station. In such circumstances, the transfer station operates as the function equivalent of a collection vehicle, having substantially identical receiving, measuring and computing means disposed therein. Thus, more rural users can recycle their goods at the transfer station, having their identity confirmed through electronic or optoelectronic means, and having their recyclable materials assessed individually for both quantity and quality. The transfer station may also be in communication with the central computer, thereby permitting a rural user to have recycling-based rewards deposited in the user account in a similar fashion as described above.

The method of the present invention cooperates with the system of the present invention to provide economic incentives for users to increase both the quantity and the quality of their recycling. In general, the method of the present invention includes the steps of receiving recyclables from a recyclables container associated with a user, electronically capturing data relating to individual recycled items, and providing a benefit to a user associated with the recyclables container in response to both the quantity and the quality of the recyclables received. The method is best performed according to the system of the present invention, and can readily be adapted for execution in both urban settings by a collection vehicle as well as in more rural areas by a transfer station.

The primary benefits of the present invention, and a significant departure over the state of the art, is the system and method for measuring the quality of individual recyclable items as they are received by the collection service. As noted above, simply measuring the gross weight of recyclable materials in an incentive-based program provides ample opportunity for abuse by users, negatively impacting the entirety of the recycling program. The present invention specifically addresses this and other problems by measuring and assessing the quality of recyclable goods, and providing rewards to users based in part on the quality of the recyclables. In doing so, the present invention promotes a system and method for incentive-based recycling that ensures ample economic rewards to individual users while maintaining the proper economic incentives for collection service entities to increase their recycling efforts, all of which will continue to promote increased environmental health and economic sustainability within communities.

The invention provides a method for promoting recycling which includes step a) receiving recyclables from a recyclables container associated with a user, step b) electronically capturing data relating to individual recycled items received in step a) and step c) providing a benefit to the user associated with the recyclables container.

The receipt of step a) and the capture of step b) may be carried out on a collection vehicle, and/or carried out at a transfer station. The recyclables container can be associated with a user through an RFID tag, wherein the RFID tag may be attachable to the recyclables container. Further, the RFID tag can be presented by the user at the time that the recyclables are received

According to another feature of the invention, the recyclables container can be associated with a user based on proximity to a physical street address. Further, the recyclables container may be associated with a user based on GPS coordinates. The benefit to the user can be a function of the aggregated weight of the individual recycled items associated with the recyclables container, such that the benefit is a function of the quality of recyclable materials.

According to another feature of the invention, step b) can be performed by an optical instrument, wherein the optical instrument is an optical sensor having an emitter for emitting radiation into the recyclables and a receiver for receiving an optical signal transmitted through, refracted by, or reflected by the recyclables. Further, the optical instrument may be a camera, wherein the camera is a video camera usable with software adapted for recognizing predetermined individual recyclable elements.

The benefit to the user may be provided as a gift certificate usable by the user, wherein the benefit to the user is provided as a credit to a user account.

According to another feature of the invention, the invention provides for a system for promoting recycling. The system includes a dumping mechanism operable from a collection vehicle, the dumping mechanism adapted for retaining a recyclables container and dumping the recyclables container into a vehicle compartment. Further, an electronic measurement system connectable to the dumping mechanism and adapted for determining the presence of individual recyclables receivable from the recyclables container. Further still, a controller disposed within the vehicle and coupled to the electronic measurement system, wherein the controller can be adapted to receive signals from the electronic measurement system indicative of the presence of individual recyclables within the recyclables container. Further, the system may be adapted to associate the presence of the individual recyclables with a user associated with the recyclables container.

The electronic measurement system can include a camera disposed on the collection vehicle and connected to the controller, such that the camera is positioned for recording visual indicia of the quality of those recyclables being deposited in the collection vehicle. Further, a GPS device can be disposed within the collection vehicle and connected to the controller. Further still, a central computer can be disposed remotely from the collection vehicle, wherein the central computer may be adapted for communication with the controller. It is also possible for a wireless communications device to be disposed within the controller for communication with the central computer.

According to another feature of the invention, the central computer can be adapted to be accessible to a user associated with a recyclables container. Further, the electronic measurement system may include a weighing system for measuring a quantity of individual recyclables receivable from the recyclables container. Further still, an RFID reader may be disposable within the collection vehicle and/or truck for communicating with an RFID tag associated with the recyclables container. The RFID reader can be coupled to the controller, wherein the controller is adapted to associate a user with the recyclables container in response to signals received from the RFID reader.

A bar code reader may be disposable within the collection truck for communicating with a bar code associated with the recyclables container. Further, the bar code reader can be coupled to the controller, wherein the controller is adapted to associate a user with the recyclables container in response to a signal received from the bar code reader. Further still, the electronic measurement system can include an optical sensor adapted for differentiating between materials having different optical properties. Wherein the optical sensor is coupled to the controller, such that the controller is adapted to receive and store information relating to the optical properties of the recyclables.

The instant invention is directed to a method for promoting recycling, including: a) receiving recyclables from a recyclables container associated with a user; b) electronically capturing data relating to individual recycled items received in step a); and c) providing a benefit to the user associated with a recyclables container.

According to an embodiment of the present invention, a system for promoting recycling including: a) a dumping mechanism operable from a collection vehicle, the dumping mechanism adapted for retaining a recyclables container and dumping the recyclables container into a vehicle compartment; b) an electronic measurement system connectable to the dumping mechanism and adapted for determining the presence of individual recyclables receivable from the recyclables container; and c) a controller disposed within the collection vehicle and coupled to the electronic measurement system, the controller adapted to receive signals from the electronic measurement system indicative of the presence of individual recyclables within the recyclables container, and further adapted to associate the presence of the individual recyclables with a user associated with the recyclables container.

According to another embodiment of the instant invention, a system for managing a recycling program including: a) receiving waste materials from a user; b) receiving recyclable materials from the user; c) measuring a quantity of waste materials received; d) measuring a quantity of recyclable materials received; and e) calculating a user-specific diversion rate based upon the ratio of recyclable materials as compared to the sum of recyclable materials and waste materials.

Other exemplary embodiments and advantages of the present invention may be ascertained by reviewing the present disclosure and the accompanying drawing.

### BRIEF DESCRIPTION OF THE FIGURES

The present invention is further described in the detailed description which follows, in which like reference numerals represent similar parts throughout the several views of the drawings, and wherein:

FIG. 1 is a schematic block diagram of a system for identifying and processing recyclables in accordance with the present invention.

FIG. 2 is a schematic block diagram of another aspect of the system for identifying and processing recyclables in accordance with the present invention.

FIG. 3 is a schematic block diagram of another aspect of the system for identifying and processing recyclables in accordance with the present invention.

FIG. 4 is a schematic block diagram of another aspect of the system for identifying and processing recyclables in accordance with the present invention.

FIG. 5 is a flow chart depicting a method for identifying and processing recyclables in accordance with the present invention.

FIG. 6 is a flow chart depicting a method for providing incentives for a user to recycle in accordance with the present invention.

FIG. 7 is a flow chart depicting a method for providing feedback to third parties regarding the recycling of their respective products, packages and the like, in accordance with the present invention.

FIG. 8 is a flow chart depicting a method for providing feedback to a user regarding the quality of its recyclables in accordance with the present invention.

FIG. 9 is a flow chart depicting a method for monitoring the usage of containers usable in accordance with the present invention.

### DETAILED DESCRIPTION OF THE PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The present invention, according to its various aspects and embodiments, provides numerous solutions to the aforementioned problems relating to recycling. In particular, the present invention provides means through which a user, defined herein as a recycling entity, is encouraged to continue its recycling behavior through various rewards systems and economic benefits, each of which contribute to the overall efficiency and sustainability of a recycling program.

With respect to the present invention, the point of departure from the prior art lies in the electronic capture of data relating to individual recycled items, and the electronic association of this data with a user from whom the recyclables are received. A wealth of knowledge can be gained from the mining of this electronic data, and this information can be used for a variety of purposes. For example, information relating to the recycling behavior of a user of a recycling system can be used to promote, based on incentive, improved recycling behavior. As will be discussed in greater detail below in connection with specific figures, such rewards can be provided in a variety of formats. As a general proposition, it will be recognized that the electronic capture of data relating to individual recycled items received from a user can be recorded, and improvement in recycling behavior by the user can be rewarded over time.

Electronic data capture can be accomplished in a variety of ways, as will be discussed in greater detail in connection with specific figures below. Some forms of electronic data capture will provide information relating to the type of material being recycled (e.g., glass, aluminum, specific types of plastics, etc.). In many instances, the identity of the of the manufacturer who placed the product associated with the recycled material into the stream of commerce may be identifiable. For example, using optical recognition software, electronic images of recyclables from a user's recycling container may be scanned and the corporate entity associated with the product originally packaged in the recyclable identified. Information of this type is of great value to the corporate entity referred to in the preceding sentence. For example, information relating to the success of a geographic marketing program can be directly assessed.

In all embodiments of the present invention, recyclables received are associated with a user. The user may be an individual, or a user consortium such as a family, a classroom in a school, residents of a particular apartment building, etc. The recyclables may be received from a conventional curbside recyclables container or tote. Alternatively, the recyclables may be received at a transfer station in situations where curbside recycling is impractical due to population density considerations (e.g., in urban areas or in rural areas).

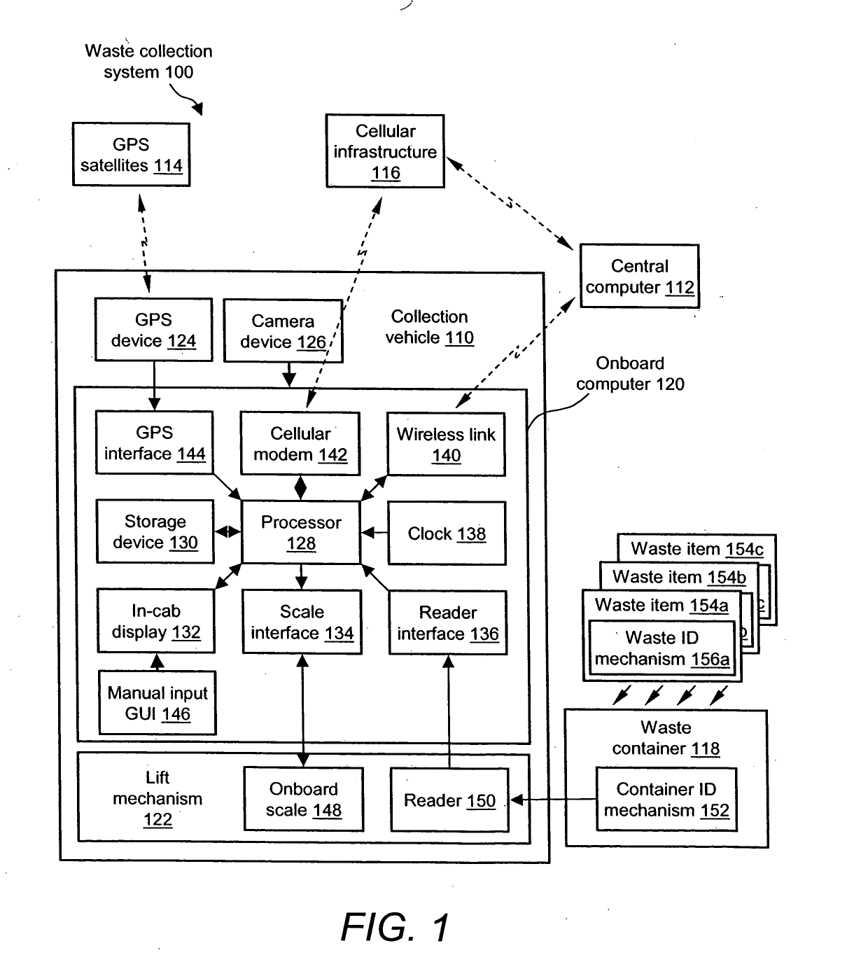

The recyclables received are associated with a user, and this association is recorded electronically. For example, in a curbside recycling environment, the recyclables container may bear an RFID tag, which is identified by a reader at the time of pickup. Alternatively, in the absence of specific RFID tags, GPS data may be recorded which identifies the specific location of the pickup vehicle at the time that a particular recycling container is picked up. The user may be inferred from the GPS data in this context. In the rural or urban settings in which curbside pickup is impractical, a user may be associated with recyclables through the presentation of an identification card or key fob which may be read electronically by a card reader or bar code scanner at a transfer station. These few examples are not intended to be limiting—one skilled in the art will recognize many ways in which received recyclables can be electronically associated with a particular user or user consortium. FIG. 1 is a schematic block diagram of a system 100 for managing a recycling program in accordance with the present invention. The system 100 generally includes a collection vehicle 110 that is in communication with, preferably over wireless or cellular protocols, a central computer 112. The collection vehicle 110 includes an onboard computer 120 that is in communication with at least the central computer 112 and a cellular infrastructure 116 for facilitating communications there between. The onboard computer 120 is further adapted for communication with at least one electronic measurement system 126, such as for example a camera or optical sensor, and a Global Positioning System (GPS) transceiver 124. The GPS transceiver, in turn, is communicable with one or more GPS satellites 114 for ascertaining the position of the collection vehicle 110.

The electronic measurement system 126 may be one of several portable devices usable for automated data capture, including capturing data indicative of both the quantity and the quality of the recyclable materials disposed within the collection vehicle 110. In particular, the electronic measurement system 126 should be adapted for determining the presence and quality of any individual recycled item. As such, the electronic measurement system 126 may be a video or still camera that is adapted for capturing digitized images of the recyclable materials as they enter the collection vehicle 110. Such images are readily convertible into files for storage and review by the onboard computer 120 described herein. Alternatively, the electronic measurement system 126 may be an optical sensor adapted for determining the optical properties of certain materials, such as for example plastics and glass materials by measuring the respective reflective, refractive, and transmission properties thereof. Such an optical sensor preferably consists of an emitter and a receiver, the emitter adapted for emitting electromagnetic waves of a predetermined frequency, and the receiver adapted for receiving electromagnetic waves across a spectrum containing any refracted, reflected or transmitted waves. According to the present invention, the electronic measurement system 126 further includes any associated software and hardware components usable in converting raw data into digital data usable by the system 100 in identifying and determining the quality of individual recyclable items deposited by a user.

The collection vehicle 110 preferably may include a lift mechanism 122, such as a mechanical arm or similar device that is adapted to automatically maneuver a container 118 into a dumping position, whereby the contents of the container 118 are deposited into the collection vehicle 110. The lift mechanism 122 preferably may include an onboard scale 148 or other suitable weighing means for determining a weight of the contents of the container 118. Other possible measuring devices used can include sensors and/or cameras that determine the volume of the recyclables container, measured markings on the container, or other electronic or mechanical means that determine the amount of the recyclables delivered. The lift mechanism 122 can also be connected to or operate in concert with a reader 150 that is communicable with a container ID mechanism 152 disposable on the container 118. The container ID mechanism 152 may be of the type permitting remote identification and transmission of identifying data, such as one of a radio frequency identification (RFID) tag, a bar code, and any other suitable optical or electromagnetic identification means (and its associated electronics and circuitry). Furthermore, the lift mechanism 122 operates in conjunction with or cooperates with the electronic measurement system 126 to ensure that the mass of the contents of the container is commensurate with the quantity and quality of the contents as determined by the electronic measurement system 126.

The present invention is an improvement over the prior art systems by providing redundant and complimentary measurement systems, i.e. the onboard scale 148 for determining the weight of the recyclables and the electronic measurement system 126 which measures the quantity and quality of those recyclables. Notably, the system 100 provides a mechanism for inducing users to recycle in high volumes while ensuring the recyclables are of sufficient quality to improve the processing and reuse thereof.

In preferred embodiments, the system 100 is distributable over a network or grouping of collection vehicles 110 that are in communication with one or more central computers 112, which may be configured as one or more processors connected to each other through a network. Likewise, the system 100 of the present invention 100 may be usable with any number of containers 118, each container being identified with a user through its respective container ID mechanism 152. Additionally, a user or group of users may require more than one container 118, such as one container each for waste, recycling, compost and the like; thus multiple container ID mechanisms 152 can be electronically configured for identifying a single user or group of users.

The onboard computer 120 of the system 100 includes a plurality of components that are known in the art and selected components that are unique to the present invention. A processor 128 is coupled to a scale interface 134, adapted to communicate with the onboard scale 148, and a reader interface 136, adapted to communicate with the reader 150. The processor 128 is further coupled to a GPS interface 144, adapted to communicate and receive data from the GPS device 124 that is indicative of the position of the collection vehicle 110. The processor 128 is further coupled to a cellular modem 142 and a wireless link 140, each of which may provide a discrete or redundant communications link between the collection vehicle 110 and the central computer 112. A clock 138 and a storage device 130 are also shown coupled to the processor 128, as well as an in-cab display 132 and a manual input GUI 146.

The storage device 130 is preferably of sufficient size to store electronic data relating to the time, location, quality and quantity of the materials received from each of the plurality of containers with which the collection vehicle interacts throughout an extended time interval. Moreover, the storage device 130 should be of sufficient size to store digital data received from the electronic measurement system 126, such as for example video or picture data received at each stop made by the collection vehicle 110. Moreover, the data stored on the storage device 130 should be readily retrievable by the processor 128 and preferably transmittable in a compressed and encrypted format for communications with the central computer 112, through either a direct wireless link 140 or through the cellular infrastructure 116. Cooperating with the onboard scale 148 and the electronic measurement system 126, the onboard computer 120 is adapted to process and store data relating to the user identity and the quantity and quality of the recyclable materials and transmit that data as described above to the central computer 112.

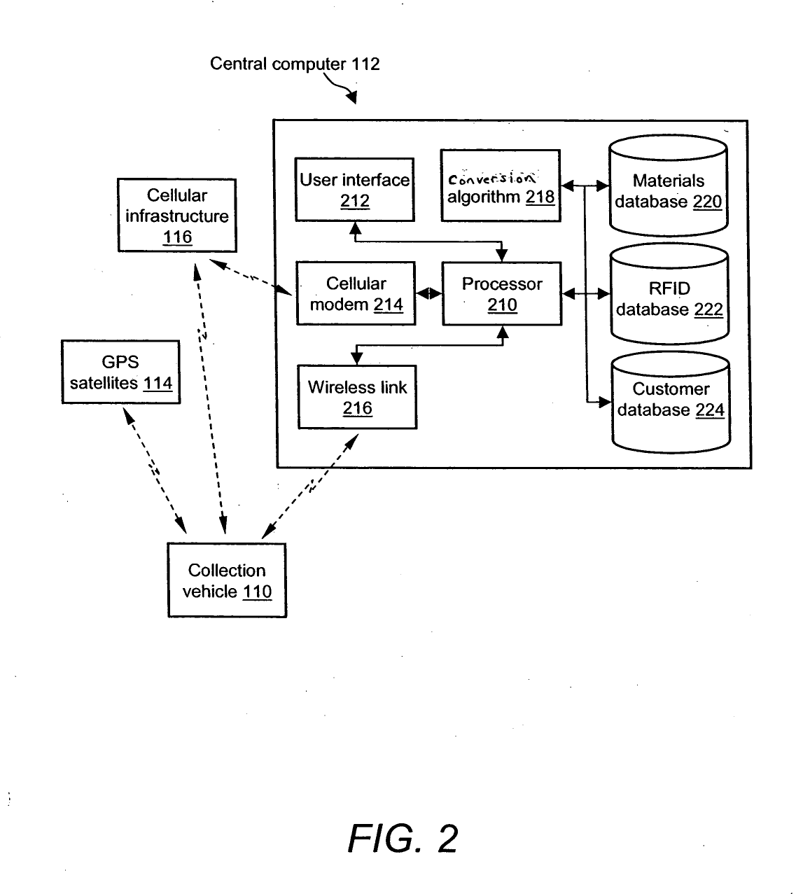

Aspects of the central computer 112 are shown schematically in FIG. 2. As shown herein, the central computer 112 is a unitary element, but it should be understood by those skilled in the art that the central computer 112 may also be a system or network of computers and databases that operate in concert to produce the functional results described herein. The central computer 112 includes at least a processor 210, a user interface 212, a cellular modem 214 and a wireless link 216. Moreover, the processor 210 is connectable with or coupled to a materials database 220, a user ID database 222, and a customer database 224, all of which may be local or remote from the central computer 112.

In more rural areas, users may not have a collection service that uses collection vehicles 110 to retrieve the recyclables. Such users generally deposit both waste and recycling at a transfer station 226, which is also connectable to the central computer 112 as shown in FIG. 2. In such instances, the transfer station 226 may be equipped with suitable hardware and software, substantially identical to that found on the onboard computer 120 for receiving data regarding the quantity and quality of individual recyclables. For example, the transfer station 226 may include a scale, such as a load cell or electronic scale, for measuring a weight of recyclables, as well as an electronic measurement system 126 for determining both a quantity and quality of recyclables. Interaction between a user and the transfer station 226 may include those means described above, such as RFID and other electronic and optoelectronic methods for establishing the identity of a user and a container. In preferred embodiments, a rural user may be provided with an RFID key fob or a magnetic swipe card that contains embedded data regarding the identity of the container and the user.

The central computer 112 preferably contains sufficient storage capacity to receive and process data from a plurality of collection vehicles 110, each of which are transmitting data regarding the quantity and quality of recyclable materials received from a plurality of users. This data is readily associated with each individual or group of users in the customer database 224, from whence the central computer 112 can retrieve the data and convert the recyclable materials into rewards or benefits for the user utilizing a conversion algorithm 218. The conversion algorithm 218 is preferably embodied in software operating on the central computer 112, the software adapted for performing calculations that convert a raw quantity and quality of recyclable goods into a reward or benefit usable by an associated user.

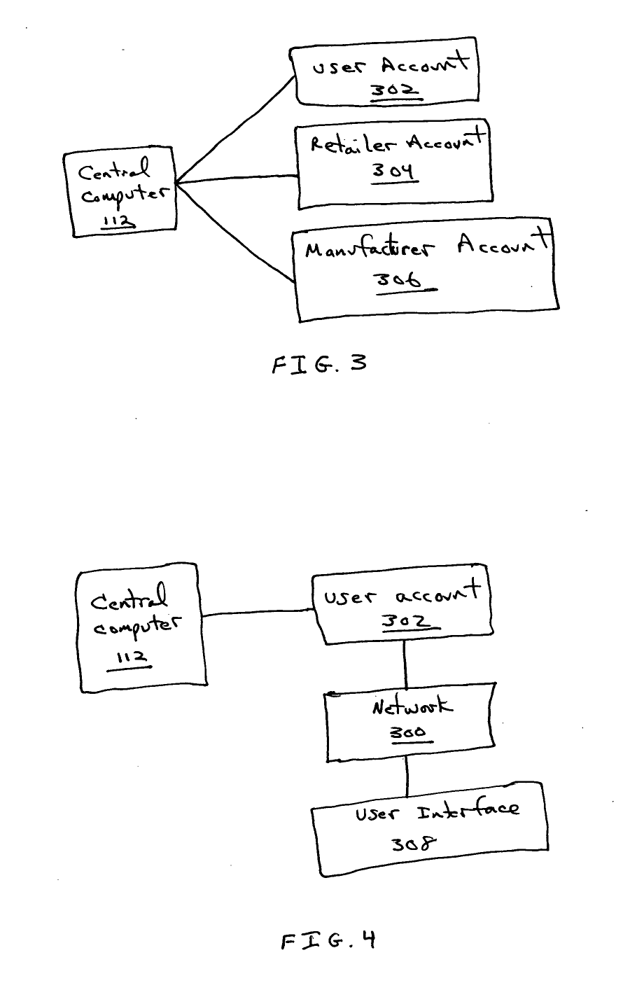

FIG. 3 is a schematic block diagram illustrating aspects of the system 100 of the present invention that permit communication of data relating the quantity and quality of recycled goods and other data to various entities. As shown, the central computer 112 is in communication with a plurality of accounts, including a user account 302, a retailer account 304 and a manufacturer account 306. Although only one account of each type is shown herein, it should be understood that according to the system 100, the central computer 112 is communicable with any number of user accounts 302 for a plurality of users. According to the present invention, the term user should be construed as broadly as possible as any recycling entity, including at least without limitation residential users, commercial users, government users and user consortiums such as apartment buildings, universities and office complexes. A plurality of retailers may establish retailer accounts 304 for receiving data regarding the recycling of goods that they sell. Similarly, it should be expected that a plurality of manufacturers may establish manufacturer accounts 306 for receiving data regarding the recycling of goods that they manufacture.

The system 100 provides for data processing and access for recycled goods at a number of levels, ranging from the consumer/recycler/user to the retailer/seller and the manufacturer of the respective goods. For example, the system 100 may provide data back to the consumer/recycler/user in the form of a report or reports, pertaining to the recycled goods delivered, including but not limited to, volume, quantity, quality, type of material (notifying the user of which products provide the best recycled benefit, i.e., coupon or credit), exception reports, contamination reports, means for differentiating types of materials (such as HDPE levels 1-7 and/or natural HDPE biodegradable types), photos detailing data received and progress reports for the consumer/recycler/user. The consumer/recycler/user reports can be used to alert the consumer/recycler/user of contaminates in the recycled goods delivered, as well as assist the consumer/recycler/user in maximizing their best possible return on advantages gained from recycling, i.e., getting more coupons (for credits) so as to further their purchasing power. Further, the system 100 may provide data to retailers/sellers in the form of reports, (either in whole or in part) which could provide the above received information for the recycled goods delivered, along with reports for projected receivables of recyclable goods and recycled geographic location reports to assist retailers/sellers in addressing growth of the recycling industry. It is also possible the above data (gathered from the delivered recycled goods) could be arranged to assist in the promotion and marketing for the retailers/sellers. Further still, the system 100 may provide data to manufacturers to assist in consumer consumption (i.e., geographic areas, seasonal consumption) so as to assist manufacturers in projections for production (or non-production). It is also possible, such data can be readily associable by the central computer 112 for determining what types of goods are most readily recyclable, as well as those manufacturers that make or supply those goods. In doing so, the system 100 provides for targeted benefits or rewards to the users depending upon the recycling rates of the respective retailers and manufacturers. For example, a manufacturer of recyclable plastics may see a high volume of its materials recycled by various users. Accordingly, the benefits provided to the users may be associated with goods manufactured by that particular manufacturer, or with a retailer that sells a high volume of goods from that manufacturer. As such, the system 100 of the present invention provides reinforcing feedback between the user/recycler and the retailer/manufacturer by providing, for example, coupons for purchases to the user that will enable it to purchase goods sold by the retailer and made by the manufacturer. Thus, the user has continued incentive to recycle, and the retailer and manufacturer have continued incentives to sell and make those recyclable goods, respectively.

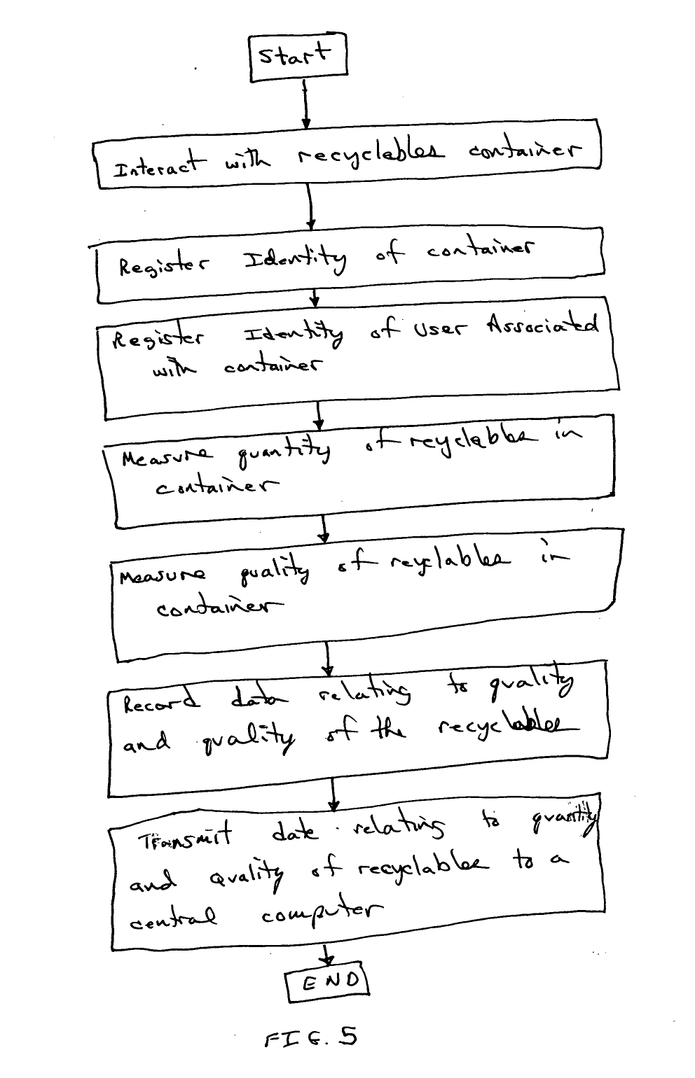

Interaction between the central computer 112 and the users is facilitated by a network structure as shown in FIG. 4. The central computer 112 is further associated with a plurality of accounts, such as the user account 302 shown, each of which is accessible through a network 300 by a user having access to a user interface 308, such as a personal computer. The central computer 112 retrieves and stores information and data relating to a user's recycling, and establishes a user account through which a user may view its recycling data, view any benefits received in response to the recycling data, and receive some benefits, i.e. coupons or rebates, provided to the user according to the present invention. Thus, in the case of a residential user, he or she can access his or her account, view his or her recycling data, and retrieve any benefits calculated according to the present invention. Likewise, a commercial user can access its account, view its recycling data, and access and benefits that are due, including pecuniary benefits and discounts for commercial purchases, i.e. particularly paper products. Moreover, the network 300 is usable for directing benefits to a user's attention, including especially through an email account associated with the user account in both the residential and commercial contexts. As such, benefits can be immediately computed and directed or pushed to a user's attention through the network 300 and associated components described above.

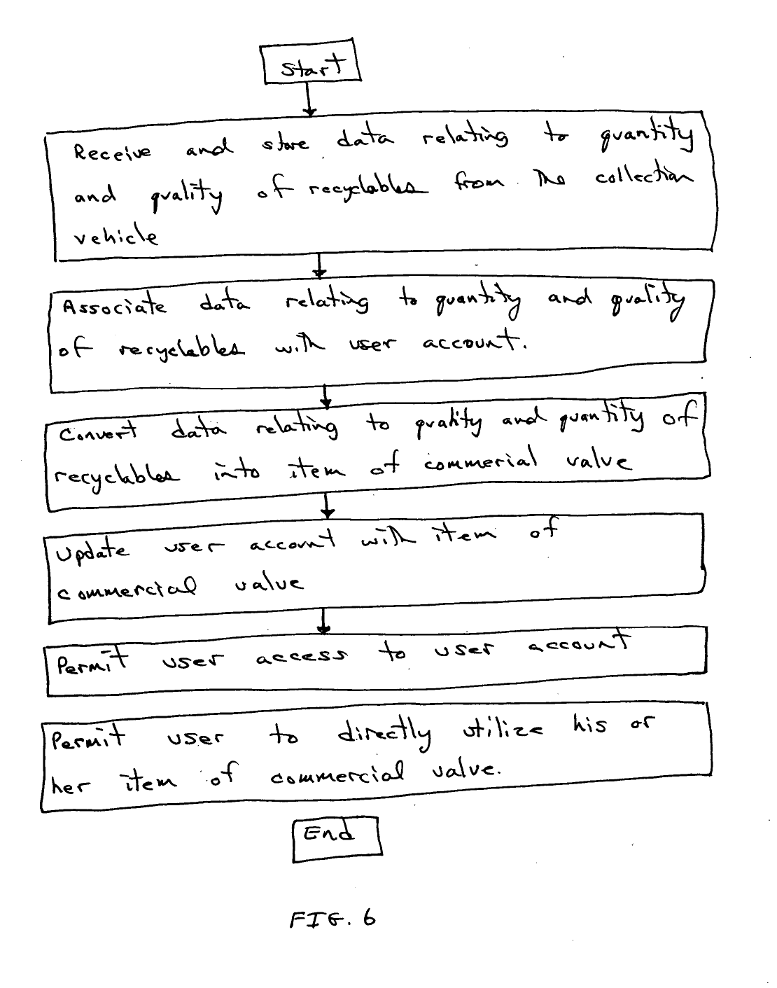

The system 100 of the present invention, as described above, is best implemented according to the methodology of the present invention as described with reference to the following figures. Likewise, the methods described herein are best practiced according to the system 100 and its various components described above. FIG. 5 is a flow chart depicting a method for identifying and processing recyclables in accordance with the present invention. In step S502, the method recites interacting with a recyclables container. In preferred embodiments, the interaction includes engaging the recyclables container with a collection vehicle, wherein the recyclables container is associated with a user through a residential, commercial or other address or user account. Alternatively, the interaction step might include receiving recyclables from a user through a transfer station 226 or other collection post that is associated with the system 100 described above.

In step S504, the identity of the recyclables container is registered. In one embodiment, this step may include the use of the collection vehicle and associated components, such as an RFID reader and an RFID tag disposed on the container as described above. Other methods of registering the identity of the container include providing a user with a portable RFID tag, such as on a key fob for example, and disposing an RFID reader at a transfer station 226. Alternatively, the user may be provided with a magnetic card or other portable device for registering the identity of the container at the time of the recycling deposit. Other methods of electronically or automatically determining the identity of the container are also suitable for performing step S504 of the present invention, including but not limited to those electronic and optoelectronic methods described above with reference to the system 100 of the present invention.

In step S506 of the present invention, the method recites registering the identity of the user associated with the container. As noted above, this step is preferably implemented according to the system 100 described above, which may include association of a user with the container through RFID or other electronic, optoelectronic or automatic determination of the identity of the container. For example, an RFID tag disposable on or attachable to a container may be configured to store and transmit data indicating the user identity as well as the identity for the container, all of which data can be readily processed by the onboard computer 120 of the collection vehicle 110. Alternatively, the identity of the user may be determined through the GPS device 124 described above by noting the proximity of the container to a physical location, such as a street address, and then correlating the position of the container according to the GPS device 124 with the known identity of the user associated with the physical location of the container. In the more rural settings that employ transfer stations 226, the identity of the user may be best determined through RFID tags or magnetic strip cards, both of which are readily employable by users and may be configured to store and transmit data regarding a user identity to be readily associated with the container.

In step S508, the method recites measuring a quantity of recyclables in the container. As previously noted, the system 100 of the present invention provides for redundant means by which this measurement can take place. First, the weight of the recyclables can be obtained through the onboard scale 148 present with the lift mechanism 122 of the collection vehicle 110. Alternatively, the weight of the recyclables can be ascertained using planar load cells or other weight measuring means known in the art. Practice of the method at a transfer station 226 obviates the need for a collection vehicle 110, thus the preferred means in those applications maybe load cells, planar scales and the like. The electronic measurement system 126 of the present invention is also usable in determining the quantity of recyclables in the container, and in particular for providing an assessment as to the nature of the individual recyclable goods being deposited, i.e. whether the user is inadvertently or intentionally combining non-recyclable goods with its recyclables. As previously noted, this redundancy in quantity measurement is a significant departure from the prior art, in which only the weight is measured, and moreover in that the present invention provides a determination as to the presence of each individual recyclable item, as opposed to a crude, bulk measurement of the weight of a container's goods.

In step S510, the method recites measuring the quality of the recyclables in the container. S510 includes an individual assessment of the quality of each individual recyclable item as determined by the electronic measurement system 126 described above. In doing so, step S510 includes the acquisition of certain data, including for example video or photographic images of the recycled items that are readily digitized and processed as described above. While visual presentation of the recyclables may be a preferred method of ascertaining the quality thereof, it is also possible to make such a determination using optical and optoelectronic devices as described above. Another advantage of visually, as opposed to optically, measuring the quality of the recyclables is that it provides for ready recognition of certain types of goods that may be associated with retailers or manufacturers, thus aiding the incentive-based recycling model described above with reference to FIG. 3.

In step S512, the data generated in the preceding steps including the quantity and the quality of the recyclables is recorded. Recordation includes at least storing the data in an electronic medium for easy transmission to the central computer 112 described above. In those embodiments in which a transfer station 226 is utilized, it is preferable for the data to be recorded at the transfer station on a local computing device.

In step S514, the data can be transferred directly to the central computer 112 through wired or wireless means known in the art. Alternatively, the data can be collected by a collection vehicle 110 at the transfer station 226 when it collects the recyclables, from where it can be transferred according to the methods and systems described above.

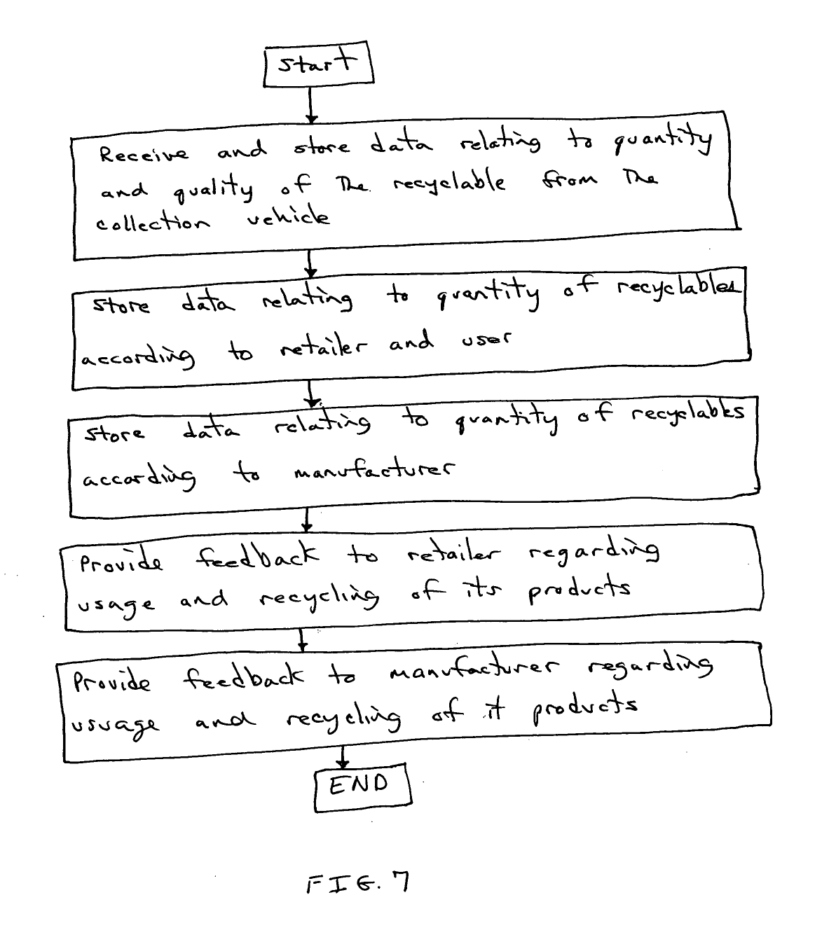

FIG. 6 is a flow chart depicting a method for providing incentives for a user to recycle in accordance with the present invention. In step S602, the method recites receiving and storing data relating to the quantity and quality of recyclables, wherein the receiving and storing is preferably performed by the central computer 112 of the system 100. The data may be transmitted by a collection vehicle 110 or a transfer station 226 as described above. In preferred embodiments, the data is collated by user and container prior to transmission to the central computer 112, although such collation may also be performed by the central computer 112 as it receives and stores the data. Transmission of the data is preferably done over a secure network, such that individual user information, including for example the user's identity, can be safely transferred without risk of interception or tampering.

In step S604, the data relating to the quantity and quality of recyclables is associated with a user account, again preferably by the central computer 112 which is coupled to both the means for data acquisition and the user accounts. The association is accomplished by correlating the data relating to the container, retrieved from a collection vehicle 110 or a transfer station 226, to existing data pertaining to a user account associated with the user.

In step S606, the recycling data for each user, including both the quantity and quality of recyclables deposited, is converted into an item of commercial value by the conversion algorithm 218 of the central computer 112. The item of commercial value may be a coupon, reward, discounted pricing on collection service, or any other transferable item that is of value to a residential user, commercial user, government user or consortium of users. Most typically, the item of commercial value will be a coupon or reward that is usable by a user in the purchase of consumer or business goods, such as those found in retail stores.

The item of commercial value is deposited in the user account in step S608. This step may include submitting an electronic coupon or rebate, or it may come in the form of a credit or discount to be applied to the collection service. Alternatively, for those users in rural settings, the item of commercial value may be directly deposited on the key fob or magnetic swipe card that the user uses for identification during the collection process. In such an instance, the item of commercial value may include a monetary credit directly applied to a magnetic swipe card, such as for example a credit or debit card commonly available and used frequently in commerce. Likewise, for other users, the item of commercial value may be a monetary credit directly applied to the user account, which may be associated with a debit card, credit card, or bank account associated with the user account for purposes of paying for the collection service. Alternatively, the item of commercial value may be a coupon or discount to be used for specific consumer or business products made by specified manufacturers and sold by specified retailers, wherein those products are commonly recycled, as determined by the system 100 and described above.

The user is permitted access to the user account in step S610. Preferably, access is permitted through a computer network as described with reference to FIG. 4. However, it may be the case that some users do not have access to a computer or the Internet. In such a case, a user will be able to access the user account through a customer service department with access to the central computer 112. Generally, the customer service department will be associated with the collection service, which is the most preferable operator of the system 100 and methods of the present invention.

In step S612, the item of commercial value can be directly usable by the user. For example, the item of commercial value may be a coupon or rebate that is directed to the user through regular mail or electronic mail. Alternatively, the item of commercial value may be directly credited to a credit card, debit card, or bank account associated with the user account. In each of the foregoing examples, the user is permitted access to the item of commercial value, which increases the user's incentive to recycle high-quality goods during the next collection cycle.

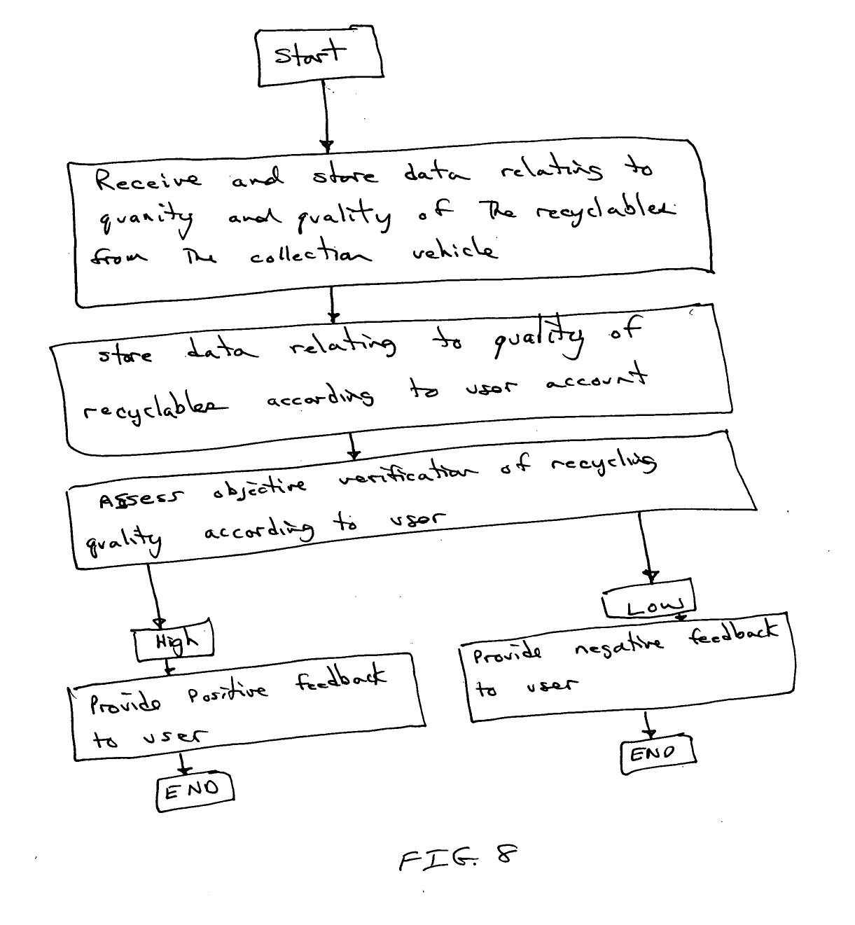

The present invention further includes a method for providing feedback to various retailers and manufacturers of recyclable goods, as shown in the flow chart of FIG. 7. In step S702, the method recites receiving and storing data relating to the quantity and quality of recyclables, wherein the receiving and storing is preferably performed by the central computer 112 of the system 100. The data may be transmitted by a collection vehicle 110 or a transfer station 226 as described above. In preferred embodiments, the data is collated by user and container prior to transmission to the central computer 112, although such collation may also be performed by the central computer 112 as it receives and stores the data. Transmission of the data is preferably done over a secure network, such that individual user information, including for example the user's identity, can be safely transferred without risk of interception or tampering.

In step S704, the data relating to the quantity and quality of recyclables is associated with a user account and a retailer account, again preferably by the central computer 112 which is coupled to both the means for data acquisition and the specified accounts. The association is accomplished by correlating the data relating to the container, retrieved from a collection vehicle 110 or a transfer station 226, to existing data pertaining to a user account associated with the user and a retailer account associated with a typical good that has been recycled. For example, certain easily identifiable items, such as soda bottles for particular brands, can be readily identified by the electronic measurement system 126 using pattern or optical recognition software, or by identifying products according to their UPC codes if available. The gross quantity of those items, as computed by the central computer 112, can be associated with a particular retailer account for providing feedback to the retailer.

Similarly, in step S706, the central computer 112 stores data relating to the quantity of recyclables originating from a particular manufacturer, again associated with a manufacturer account as described above. As in the above retailer example, the electronic measurement system 126 can be configured for identifying certain types of items according to manufacturer, such that the quantity of which can then be directed to the manufacturer account.

In step S708, the method recites providing feedback to the retailer regarding the usage and recycling of its products.

Similarly, in step S710, the method recites providing feedback to the manufacturer regarding the usage and recycling of its products. In doing so, the present invention ensures that the incentives to recycle are felt at each of the manufacturing, retail and consumer levels. As noted before, one type of reward provided by the present invention is a coupon or discount on a consumer product that is sold by a particular retailer and made by a particular manufacturer. Thus, by providing feedback to retailer and manufacturers regarding the usage and recycling of their respective products, the present invention allows those parties to more effectively construct, market and sell recyclable goods, which in turn will increase sales through the reward system detailed above.

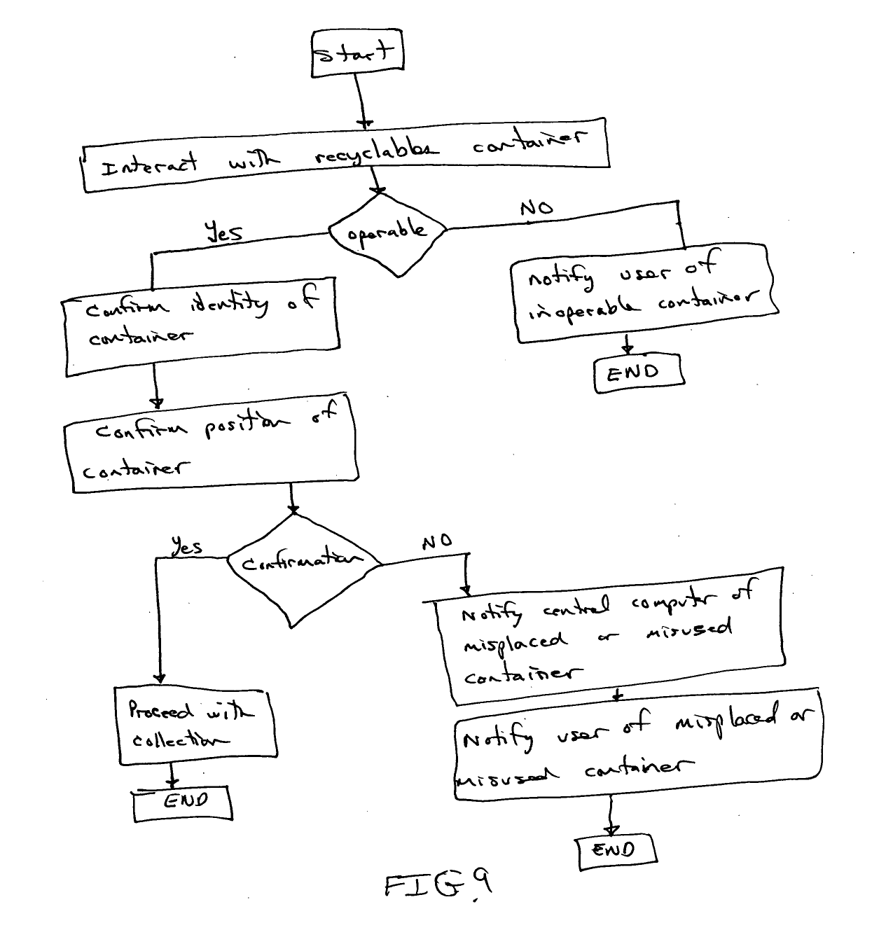

The present invention further includes a method for providing feedback to a user regarding the quality of its recyclables, as shown in the flowchart of FIG. 8. In step S802, the method recites receiving and storing data relating to the quality of recyclables, wherein the receiving and storing is preferably performed by the central computer 112 of the system 100. The data may be transmitted by a collection vehicle 110 or a transfer station 226 as described above. Quality assessment of the recyclables is preferably made in a visual medium, such as photographic or video images of the recyclables as they are deposited by the user. Subsequent review as to the qualitative nature of the recyclables can be performed by a technician. In preferred embodiments, the data is collated by user and container prior to transmission to the central computer 112, although such collation may also be performed by the central computer 112 as it receives and stores the data. Transmission of the data is preferably done over a secure network, such that individual user information, including for example the user's identity, can be safely transferred without risk of interception or tampering.

In step S804, the data relating to the quantity and quality of recyclables is associated with a user account, again preferably by the central computer 112 which is coupled to both the means for data acquisition and the user accounts. The association is accomplished by correlating the data relating to the container, retrieved from a collection vehicle 110 or a transfer station 226, to existing data pertaining to a user account associated with the user.

In step S806, the objective quality of the recyclables is assessed, preferably by automated means but also by human review of the output of the electronic measurement system 126. As previously noted, the electronic measurement system 126 may be a video or still photographic camera, or any other type of optical or electronic instrument that can provide feedback as to the recyclable content of deposited items. For example, a technician may review stored video feed in order to assess the quality of the goods, wherein the assessment is preferably conducted according to strict protocols. Automated means for assessment may include combining the electronic measurement system 126 with optical recognition software for recognizing the items deposited. Alternatively, optical scanners and electromagnetic devices may be used to determine the optical or electrical properties of the goods deposited, from which the system 100 can automatically determine the content and therefore the quality of the goods deposited.

A high quality assessment in step S810 leads to step S814, wherein the method provides positive feedback to the user. Positive feedback may include, but is not limited to, increased incentives for recycling through higher value rewards in the form of larger coupons or discounts for goods and services. Positive feedback may also include a lowered rate for a subscription-type collection service, thus effectively discounting the cost of recycling to the user, and therefore providing more incentive to do so. A low quality assessment in step S812 leads to step S815, wherein the method provides negative feedback to the user. Negative feedback may include, for example, lower value rewards in the form of smaller coupons or discounts for goods and services. Negative feedback may also include an increased rate for a subscription-type collection service, thus effectively notifying the user that low-quality recycling is economically unsound, and thereby providing more incentive for the user to recycle high-quality goods in order to lower the cost of the recycling service. In both instances, the user is notified explicitly as to the quality of the recyclable materials, such that the user can readily correlate the quality of the goods deposited with any economic incentive or disincentive determined according to the method herein.

In order to ensure an efficient and economically viable system 100, the present invention further includes a method for monitoring the usage of containers. Step S902 recites interacting with the recyclables container, which In preferred embodiments includes engaging the recyclables container with a collection vehicle, wherein the recyclables container is associated with a user through a residential, commercial or other address or user account. Alternatively, the interaction step might include receiving recyclables from a user through a transfer station 226 or other collection post that is associated with the system 100 described above. In step S904, the method queries whether the container is operable, i.e. whether the container is responding to electronic or optoelectronic requests regarding the identity of the container. If the container is not functional, for example the RFID tag associated therewith is not responding, then the method proceeds to step S908, wherein the user is notified of an inoperable container. Such notification is preferably conducted through the user account established in the system 100 of the present invention, although other means of notification such as regular mail, telephone, and the like are equally applicable to the method described herein.

If the container is operable, then the method proceeds to step S906, wherein the identity of the container is confirmed by comparing the data received from the container, for example through RFID communications, with the known identity of the container as stored on the onboard computer 120, a transfer station 226 or the central computer 112. In step S908, the position of the container is confirmed, preferably by comparing the known position of the collection vehicle 110 as determined by the GPS device 124 with the expected location of the container as stored in the onboard computer 120 or the central computer 112.

In step S910, the method queries whether the identity and position of the container is confirmed. An affirmative response directs the collection vehicle operator or transfer station operator to proceed with the collection of recyclable materials. A negative response indicates potential abuse of the system 100, and as such step S914 recites notifying the central computer 112 of a misplaced or misused container. Step S916 recites notifying the user that is actually associated with the container, preferably through the user account, that the container is potentially misplaced or being misused. As such, the method described with reference to FIG. 9 prevents any tampering with the system 100 by ensuring the identity and location of each and every container, thus preventing others from tampering with the rewards or incentives that are due the actual user.

As described above, the present invention provides both a system and a method that provide numerous solutions to the aforementioned problems relating to recycling. In particular, the present invention provides means through which a user, defined herein as a recycling entity, is encouraged to continue its recycling behavior through various rewards systems and economic benefits, each of which contribute to the overall efficiency and sustainability of a recycling program. The present invention has been described with reference to particular embodiments and specific examples. However, it should be understood that those skilled in the art can readily devise competing systems and methods that, although not specifically delineated above, fall within the scope of the present invention as defined by the following claims.

Further, it is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1) A method for promoting recycling, comprising:
a) receiving recyclables from a recyclables container associated with a user;
b) electronically capturing data relating to individual recycled items received in step a); and
c) providing a benefit to the user associated with a the recyclables container.

2) The method of claim 1, wherein the receipt of step a) and the capture of step b) are carried out on a collection vehicle.

3) The method of claim 1, wherein the receipt of step a) and the capture of step b) are carried out at a transfer station.

4) The method of claim 1, wherein the recyclables container is associated with the user through an RFID tag.

5) The method of claim 4, wherein the RFID tag is attachable to the recyclables container.

6) The method of claim 4, wherein the RFID tag presentable by the user at the time that the recyclables are received.

7) The method of claim 2, wherein the recyclables container is associated with the user based on proximity to a physical street address.

8) The method of claim 2, wherein the recyclables container is associated with the user based on GPS coordinates.

9) The method of claim 1, wherein the benefit is a function of an aggregated weight or volume of the individual recycled items associated with the recyclables container.

10) The method of claim 1, wherein the benefit is a function of the quality of recyclable materials.

11) The method of claim 1, step b) is performed by an optical instrument.

12) The method of claim 11, wherein the optical instrument is an optical sensor having an emitter for emitting radiation into the recyclables and a receiver for receiving an optical signal transmitted through, refracted by, or reflected by the recyclables, whereby providing information relating to the quality of the recyclables.

13) The method of claim 11, wherein the optical instrument is a camera.

14) The method of claim 11, wherein the camera is a video camera usable with software adapted for recognizing predetermined individual recyclable elements.

15) The method of claim 1, wherein the benefit to the user is provided as a gift certificate usable by the user.

16) The method of claim 1 wherein the benefit to the user is provided as a credit to a user account associated with the user.

17) A system for promoting recycling comprising:
a) a dumping mechanism operable from a collection vehicle, the dumping mechanism adapted for retaining a recyclables container and dumping the recyclables container into a vehicle compartment;
b) an electronic measurement system connectable to the dumping mechanism and adapted for determining the presence of individual recyclables receivable from the recyclables container; and
c) a controller disposed within the collection vehicle and coupled to the electronic measurement system, the controller adapted to receive signals from the electronic measurement system indicative of the presence of individual recyclables within the recyclables container, and further adapted to associate the presence of the individual recyclables with a user associated with the recyclables container.

18) The system of claim 17, wherein the electronic measurement system includes a camera disposed on the collection vehicle and connected to the controller, the camera positioned for recording visual indicia of the quality of recyclables deposited in the collection vehicle.

19) The system of claim 17, further comprising a GPS device disposed within the collection vehicle and connected to the controller.

20) The system of claim 17, further comprising a central computer disposed remotely from the collection vehicle, the central computer adapted for communication with the controller.

21) The system of claim 20, further comprising a wireless communications device disposed within the controller for communication with the central computer.

22) The system of claim 17, wherein the central computer is adapted to be electronically accessible to a user associated with a recyclables container.

23) (canceled)

24) The system of claim 17, further comprising an RFID reader disposable within the collection truck for communicating with an RFID tag associated with the recyclables container.

25) The system of claim 24, wherein the RFID reader is coupled to the controller, and further wherein the controller is adapted to associate a user with the recyclables container in response to signals received from the RFID reader.

26) The system of claim 17, further comprising a bar code reader disposable within the collection truck for communicating with a bar code associated with the recyclables container.

27) The system of claim 17, wherein the bar code reader is coupled to the controller, and further wherein the controller is adapted to associate a user with the recyclables container in response to a signal received from the bar code reader.

28) The system of claim 17, wherein the electronic measurement system includes an optical sensor adapted for differentiating between materials having different optical properties.

29) The system of claim 28, wherein the optical sensor is coupled to the controller, and further wherein the controller is adapted to receive and store information relating to the optical properties of the recyclables.

30) A recycling system comprising:
a) a collection vehicle adapted to deposit materials from a recyclables container into the collection vehicle;
b) an electronic device adapted to identify individual materials from the materials associated with recyclables container and by the identification of the individual materials determine the quality and quantity of the materials associated with the recyclables container; and
c) a controller disposed within the collection vehicle and in communication with the electronic device, the controller adapted to receive signals from the electronic device indicative of individual materials of the materials, and further adapted to associate the individual materials of the material with a user associated with the recyclables container.

31) The method of claim 14, wherein the electronic captured data gathered from the video device and/or the camera is stored in a storage device capable of storing and receiving a video data and/or a camera data.

32) The method of claim 2, wherein a weight of the received recyclables is determined using a weight measuring means mounted on the collection vehicle, and the determined weight of received recyclables determined using the weight measuring means, as well as the electronically captured data relating to individual recycled items, is communicated wirelessly to a central computer.

33) The method of claim 32, wherein the weight measuring means is selected from a group consisting of one of an on board scale, a weighing system, one or more measuring devices and one or more planar load cells.

34) The method of claim 33, wherein the one or more measuring devices is selected from a group consisting of one of a sensor and a camera that determines a volume of the recyclable container, one or more measured marking on the recyclable container, and an other electronic and/or an other mechanical means that determine an amount of the received recyclables.

35) The method of claim 1, further comprising review of the electronically captured data by a technician to further assess quality of received recyclables.

36) The method of claim 11, wherein the optical instrument is an electromagnetic device or an optical scanner.

37) The method of claim 1, wherein the benefit is determined by a conversion algorithm which converts a raw quantity or quality determination of received recyclables into a benefit to the user.

38) The method of claim 1, wherein the electronically captured data is associated with a report that provides an economic incentive benefit for users to increase the quantity and to improve the quality of their recycling.

39) The method of claim 10, wherein the quality is determined as the recyclables are collected by the collection vehicle.

40) The method of claim 1, further comprising calculating a user-specific diversion rate based upon a ratio of recyclable materials, such that the recyclable materials are compared to a sum of recyclable materials and waste material.

41) The method of claim 2, wherein the collection vehicle comprises at least one lift mechanism adapted to automatically maneuver one or more recyclables container into a dumping position, whereby the received recycled items are deposited into the collection vehicle.

42) The method of claim 9, wherein electronic data relating to volume is determined using a combination of measured markings on the recyclables container and a camera to record the image of the collected recyclable materials in the container.

43) The method of claim 32, wherein the determined weight of received recyclables determined using the weight measuring means is reconciled with the electronically captured data relating to individual recycled items as an internal control for accuracy.

44) The method of claim 2 wherein the collection vehicle is equipped with an on-board computer.

45) The system of claim 25, wherein the controller is programmed to query whether the RFID reader receives a signal from the RFID tag associated with the recyclables container to determine if the RFID tag is operable.

46) The method of claim 1, wherein the user is selected from a group consisting of a residential user, a commercial user, a government user and a consortium of users.

47) The method of claim 46, wherein the consortium of users includes users affiliated with one of one or more apartment buildings, one or more universities, one or more office complexes, one or more retailers and one or more manufacturers.
